(19) United States
(12) Patent Application Publication
(10) Pub. No.: US 2026/0063782 A1
(43) Pub. Date: Mar. 5, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventors: Yukihiro YANO, tOKYO (JP); Takahiro Kumura, Tokyo (JP); Kosuke Kinoshita, Tokyo (JP)

(73) Assignee: NEC Corporation, Tokyo (JP)

(21) Appl. No.: 19/305,814

(22) Filed: Aug. 21, 2025

(30) Foreign Application Priority Data
Aug. 27, 2024 (JP) 2024-145343

(51) Int. Cl. G01S 13/46; G01S 13/44

(52) U.S. Cl. CPC G01S 13/46; G01S 13/4418

(57) ABSTRACT

An information processing apparatus includes a data acquisition unit that acquires irradiation direction displacement data that indicates a displacement amount in an irradiation direction of an object, the displacement amount being generated by irradiation of the object with a radio wave from a flying object, a displacement amount estimation unit that estimates a displacement amount of the object in a first direction under a physical constraint condition on the object, a residual error calculation unit that calculates a residual error by subtracting a value obtained by projecting the estimated displacement amount in the first direction in the irradiation direction from the displacement amount indicated by the irradiation direction displacement data, and a residual error conversion unit that projects the calculated residual error in a second direction, thereby converting the residual error into a displacement amount of the object in the second direction.

This application is based upon and claims the benefit of priority from Japanese patent application No. 2024-145343, filed on Aug. 27, 2024, the disclosure of which is incorporated herein in its entirety by reference.

### TECHNICAL FIELD

The present disclosure relates to an information processing apparatus and an information processing method for calculating a displacement generated in a structure, and further relates to a computer-readable recording medium in which a program for achieving the information processing apparatus and the information processing method is recorded.

### BACKGROUND ART

In general, an infrastructure such as a bridge has a lifetime, and in recent years, aging of many infrastructures has become a major social problem. In the maintenance and management of such an infrastructure, periodic inspection is important, and the inspection is usually performed manually. However, since there is a limit in manual inspection due to the problem of labor shortage, monitoring techniques using various sensors have attracted attention.

For example, for a bridge, bridge displacement analysis using a satellite synthetic aperture radar (SAR) has been proposed. In bridge displacement analysis using the satellite SAR, radio waves are emitted from an artificial satellite toward a bridge at a set interval, and reflected waves are received. Then, the phase difference between the reflected waves is calculated by the interference processing. This phase difference is caused by displacement generated on the bridge during the irradiation interval of the radio wave. Then, the phase difference is converted into displacement using the wavelength of the radio wave.

However, the displacement calculated by the above-described bridge displacement analysis is displacement in a line-of-sight direction connecting the ground and an artificial satellite (hereinafter, referred to as “line of sight (LOS) displacement”). From this LOS displacement, it is difficult to specify the direction and magnitude of displacement generated on the actual bridge. For this reason, displacement analysis (2.5 dimensional analysis) using two artificial satellites having different orbits has been proposed (see, for example, Satoshi Fujiwara et al., “2.5-D surface deformation of M6.1 earthquake near Mt Iwate detected by SAR interferometry”, Geophysical Research Letters, Vol. 27, No. 14, pp. 2049-2052 Jul. 15, 2000).

In the displacement analysis disclosed in “2.5-D surface deformation of M6.1 earthquake near Mt Iwate detected by SAR interferometry” (Satoshi Fujiwara et al., Geophysical Research Letters, Vol. 27, No. 14, pp. 2049-2052 Jul. 15, 2000), a displacement analysis result by a north-bound orbit (ascending orbit) of a first artificial satellite and a displacement analysis result by a south-bound orbit (descending orbit) of a second artificial satellite are synthesized. As a result, the displacement of the object is decomposed into components in the quasi-east-west direction and the quasi-vertical direction.

Satoshi Fujiwara et al., “2.5-D surface deformation of M6.1 earthquake near Mt Iwate detected by SAR interferometry”, Geophysical Research Letters, Vol. 27, No. 14, pp. 2049-2052 Jul. 15, 2000.

### SUMMARY

However, there is a problem that there are very few cases where two different artificial satellites irradiate the same target with radio waves. Therefore, the object to which the displacement analysis disclosed in “2.5-D surface deformation of M6.1 earthquake near Mt Iwate detected by SAR interferometry” (Satoshi Fujiwara et al., Geophysical Research Letters, Vol. 27, No. 14, pp. 2049-2052 Jul. 15, 2000) can be applied is very limited. Therefore, it is required to specify a displacement amount in a direction in which displacement actually occurs in an infrastructure such as a bridge using only one artificial satellite.

An object of the present disclosure is to enable calculation of a displacement amount in a direction according to an analysis target using only one flying object.

In order to achieve the above object, an information processing apparatus according to an aspect of the present disclosure includes
a data acquisition unit that acquires irradiation direction displacement data that indicates a displacement amount in an irradiation direction of an object, the displacement amount being generated by irradiation of the object with a radio wave from a flying object,
a displacement amount estimation unit that estimates a displacement amount of the object in a first direction under a physical constraint condition on the object,
a residual error calculation unit that calculates a residual error by subtracting a value obtained by projecting the estimated displacement amount in the first direction in the irradiation direction from the displacement amount indicated by the irradiation direction displacement data, and
a residual error conversion unit that projects the calculated residual error in a second direction, thereby converting the residual error into a displacement amount of the object in the second direction.

In order to achieve the above object, an information processing method according to an aspect of the present disclosure includes
a data acquisition step of acquiring irradiation direction displacement data that indicates a displacement amount in an irradiation direction of an object, the displacement amount being generated by irradiation of the object with a radio wave from a flying object,
a displacement amount estimation step of estimating a displacement amount of the object in a first direction under a physical constraint condition on the object,
a residual error calculation step of calculating a residual error by subtracting a value obtained by projecting the estimated displacement amount in the first direction in the irradiation direction from the displacement amount indicated by the irradiation direction displacement data, and
a residual error conversion step of projecting the calculated residual error in a second direction, thereby converting the residual error into a displacement amount of the object in the second direction.

In order to achieve the above object, a computer-readable recording medium according to an aspect of the present disclosure has stored therein a program containing commands to cause a computer to execute
a data acquisition step of acquiring irradiation direction displacement data that indicates a displacement amount in an irradiation direction of an object, the displacement amount being generated by irradiation of the object with a radio wave from a flying object,
a displacement amount estimation step of estimating a displacement amount of the object in a first direction under a physical constraint condition on the object,
a residual error calculation step of calculating a residual error by subtracting a value obtained by projecting the estimated displacement amount in the first direction in the irradiation direction from the displacement amount indicated by the irradiation direction displacement data, and
a residual error conversion step of projecting the calculated residual error in a second direction, thereby converting the residual error into a displacement amount of the object in the second direction.

As described above, according to the present disclosure, it is possible to calculate a displacement amount in a direction relevant to an analysis target using only one flying object.

### BRIEF DESCRIPTION OF THE DRAWINGS

FIG. 1 is a configuration diagram illustrating a schematic configuration of an example of an information processing apparatus;

FIG. 2 is a configuration diagram specifically illustrating a configuration of an example of the information processing apparatus;

FIG. 3 is a diagram illustrating a reflection point and an object at which irradiation direction displacement data is generated;

FIG. 4 is a diagram illustrating an example of irradiation direction displacement data measured by an artificial satellite;

FIG. 5 is a diagram illustrating a relationship between a Los displacement and a setting direction of an object;

FIG. 6 is a flowchart illustrating an example of the operation of the information processing apparatus;

FIG. 7 is a flowchart specifically illustrating an example of estimation processing of a displacement amount in a direction of a bridge axis illustrated in FIG. 6; and

FIG. 8 is a block diagram illustrating an example of a computer that achieves the information processing apparatus.

### EXAMPLE EMBODIMENT

### Example Embodiment

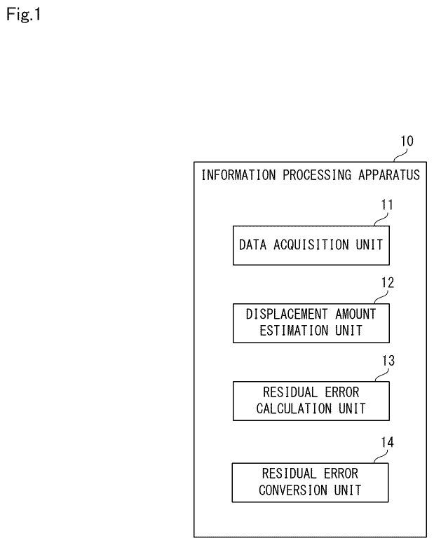

Hereinafter, in example embodiments, an information processing apparatus, an information processing method, and a program will be described with reference to FIGS. 1 to 8.

### [Device Configuration]

First, a schematic configuration of the information processing apparatus according to the example embodiment will be described with reference to FIG. 1. FIG. 1 is a configuration diagram illustrating a schematic configuration of an example of the information processing apparatus.

An information processing apparatus 10 illustrated in FIG. 1 is an apparatus for calculating a displacement generated in an object. As illustrated in FIG. 1, the information processing apparatus 10 includes a data acquisition unit 11, a displacement amount estimation unit 12, a residual error calculation unit 13, and a residual error conversion unit 14.

The data acquisition unit 11 acquires irradiation direction displacement data which indicates a displacement amount generated by irradiation of the object with the radio wave from a flying object in the irradiation direction of the object. The displacement amount estimation unit 12 estimates the displacement amount of the object in a first direction under the physical constraint condition on the object.

The residual error calculation unit 13 calculates the residual error by subtracting a value obtained by projecting the estimated displacement amount in the first direction in the irradiation direction from the displacement amount indicated by the irradiation direction displacement data. The residual error conversion unit 14 projects the calculated residual error in a second direction, thereby converting the residual error into the displacement amount of the object in the second direction.

As described above, the information processing apparatus 10 can estimate the displacement amount of the object in the first direction and the second direction only with the irradiation direction displacement data obtained from one flying object. According to the information processing apparatus 10, it is possible to calculate the displacement amount in a direction according to the object (analysis target) using only one flying object.

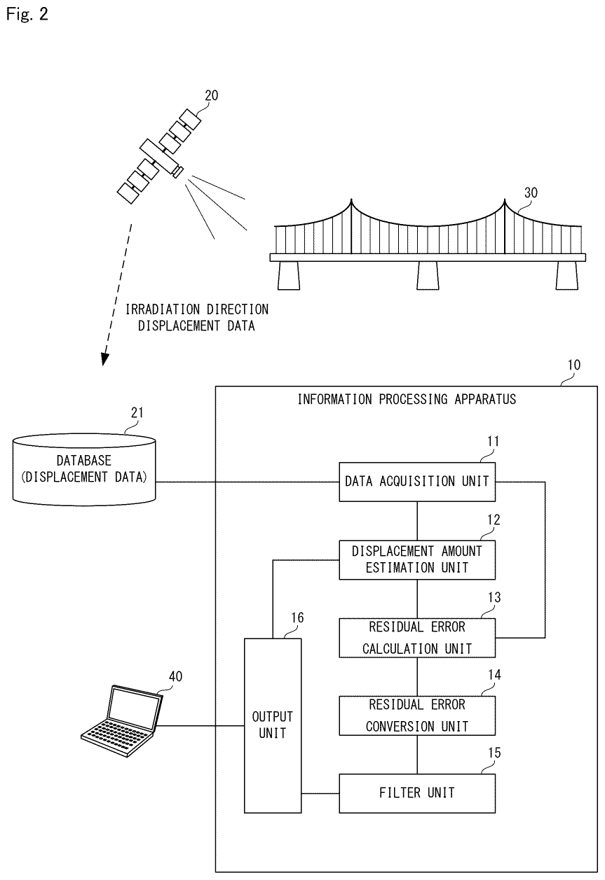

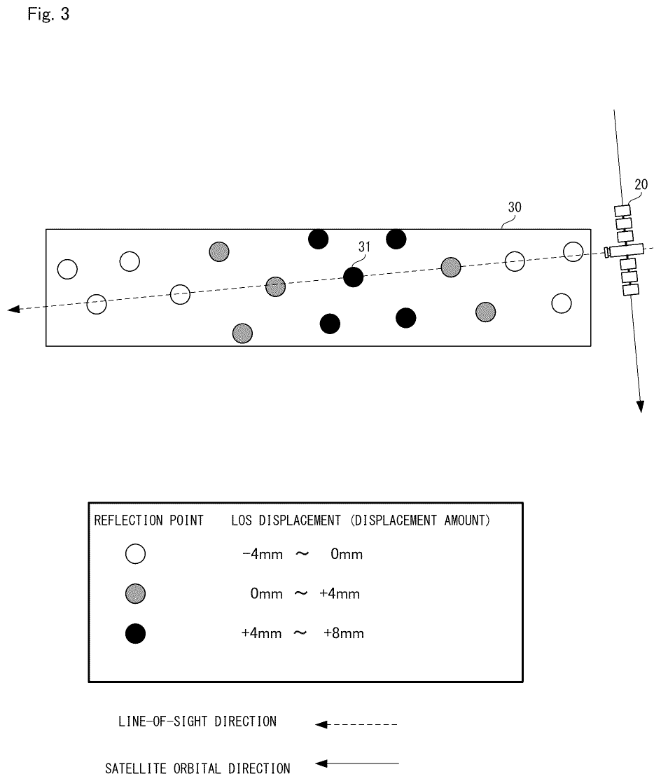

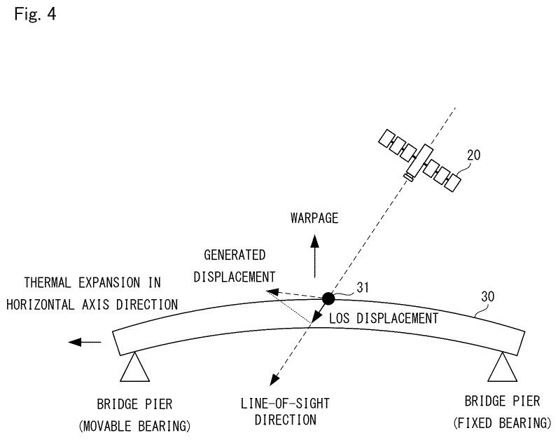

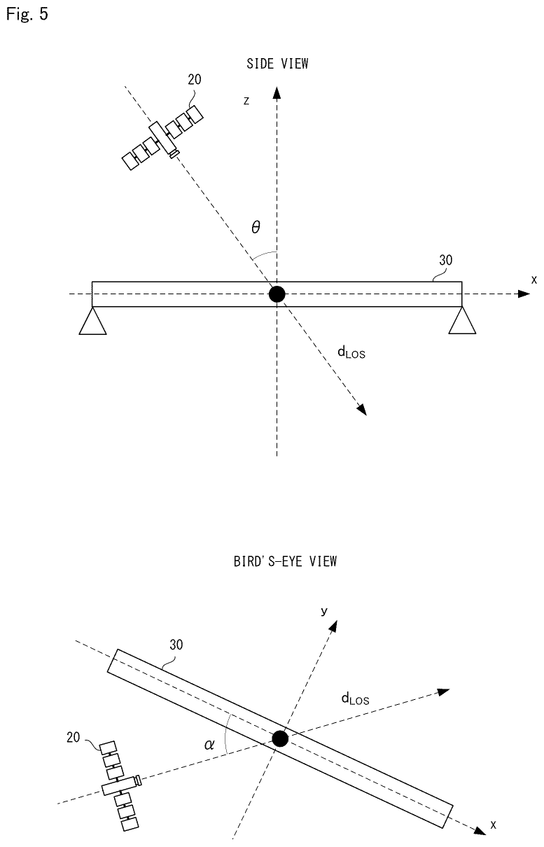

Next, a configuration and a function of the information processing apparatus 10 will be specifically described with reference to FIGS. 2 to 5. FIG. 2 is a configuration diagram illustrating a schematic configuration of an example of the information processing apparatus. FIG. 3 is a diagram illustrating a reflection point and an object at which irradiation direction displacement data is generated. FIG. 4 is a diagram illustrating an example of irradiation direction displacement data measured by an artificial satellite. FIG. 5 is a diagram illustrating a relationship between a Los displacement and a setting direction of an object.

As illustrated in FIG. 2, the information processing apparatus 10 includes a filter unit 15 and an output unit 16 in addition to the data acquisition unit 11, the displacement amount estimation unit 12, the residual error calculation unit 13, and the residual error conversion unit 14 described above. In the following description, it is assumed that the flying object is an artificial satellite 20 and the object is a bridge 30. A first direction of the object is a bridge axis direction (x direction) of the bridge 30, and a second direction is a vertical direction (z direction).

As illustrated in FIG. 3, the irradiation direction displacement data transmitted from the artificial satellite 20 is data of LOS displacement for each reflection point 31 analyzed by satellite SAR. In FIG. 3, a broken arrow indicates the irradiation direction of the radio wave from the artificial satellite 20, and a solid arrow indicates the orbit of the artificial satellite 20.

As illustrated in FIG. 4, the LOS displacement is displacement in the line-of-sight direction (irradiation direction) of the satellite. On the other hand, the displacement to be obtained is displacement in the bridge axis direction and displacement in the vertical direction of the bridge 30 as described later. In FIG. 4, the bridge is shown in a modeled manner. In the example of FIG. 4, the bridge is deformed by thermal expansion or contraction, thereby causing displacement. The bridge 30 is also deformed by a factor other than heat, for example, a load due to passage of a vehicle.

As illustrated in FIG. 2, the artificial satellite 20 transmits irradiation direction displacement data to a base (not illustrated in FIG. 2) at a set date and time or periodically. The irradiation direction displacement data received at the base is accumulated in the database 21. The irradiation direction displacement data has an observation time, and the accumulated irradiation direction displacement data is time-series data.

In the example embodiment, the data acquisition unit 11 acquires irradiation direction displacement data at each reflection point of the bridge 30 from a database 21. As described above, since the irradiation direction displacement data is acquired for each reflection point, processing by the displacement amount estimation unit 12, the residual error calculation unit 13, and the residual error conversion unit 14 is performed for each reflection point.

In the example embodiment, the displacement amount estimation unit 12 estimates a displacement amount in the bridge axis direction of the bridge 30 that is an object under a physical constraint condition of the bridge 30. Here, for example, when the object is the bridge 30, examples of the physical constraint condition include a constraint condition due to expansion and contraction due to heat, deformation due to a load, and the like.

In the example embodiment, the physical constraint condition is expressed by a constraint condition expression that defines a relationship between a displacement amount dx in the bridge axis direction (in the first direction) and a specific parameter Cₓ. Therefore, the displacement amount estimation unit 12 estimates the specific parameter Cₓ in the constraint condition expression. The displacement amount estimation unit 12 applies the estimated specific parameter Cₓ to the constraint condition expression to estimate the displacement amount dx in the bridge axis direction (first direction). The constraint condition expression is expressed by, for example, the following Expression 1.

$$dx = {f}_{x} ( {C}_{x} ) \qquad [ Math . 1 ]$$

Here, estimation processing of the specific parameter Cₓ will be described more specifically. First, a displacement amount dₗₒₛ in the irradiation direction can be expressed by the following Expression 2 using the displacement amount dx in the bridge axis direction (first direction) and a displacement amount dz in the vertical direction (second direction). The following Expression 2 is also referred to as a projection equation.

$${d}_{LOS} = dz cos θ + dx sin θ cos α \qquad [ Math . 2 ]$$

In the above Expression 2, as illustrated in FIG. 5, θ is an angle formed between the line-of-sight direction of the artificial satellite 20 and the vertical direction on the zx plane. As illustrated in FIG. 5, a is an angle formed between the line-of-sight direction of the artificial satellite 20 and the bridge axis direction on the xy plane. The y-axis direction is a direction perpendicular to the bridge axis direction and the vertical direction. In the above Expression 2, since the displacement amount dz in the vertical direction is extremely smaller than the displacement amount dx in the bridge axis direction, Expression 2 can be rewritten to the following Expression 3 using the above Expression 1.

$${d}_{LOS} = {f}_{x} ( {C}_{x} ) sin θ cos α \qquad [ Math . 3 ]$$

Therefore, the displacement amount estimation unit 12 first sets specific parameter Cₓ to an initial value, and calculates provisional displacement amount dₗₒₛ using the above Expression 3. Next, the displacement amount estimation unit 12 calculates a difference between provisional displacement amount dₗₒₛ and the displacement amount specified by the irradiation direction displacement data. Then, the displacement amount estimation unit 12 updates the specific parameter Cₓ such that the calculated difference becomes small. The displacement amount estimation unit 12 executes calculation of provisional displacement amount dₗₒₛ, calculation of a difference, and update of parameter Cₓ a set number of times. As a result, the specific parameter Cₓ with high accuracy can be obtained.

In the example embodiment, the residual error calculation unit 13 calculates a residual error E by applying the displacement amount dx in the bridge axis direction estimated by the displacement amount estimation unit 12 to the projection equation shown in the above Expression 2. Specifically, the residual error E can be represented by the following Expression 4. Therefore, the projection equation can be expressed as the following Expression 5.

$$E = dz cos θ \qquad [ Math . 4 ]$$

$${d}_{LOS} = dx sin θ cos α + E = {f}_{x} ( {C}_{x} ) sin θ cos α + E \qquad [ Math . 5 ]$$

Therefore, the residual error calculation unit 13 calculates the residual error E by applying the displacement amount specified by the irradiation direction displacement data and the displacement amount dx estimated by the displacement amount estimation unit 12 to the above Expression 5.

The residual error conversion unit 14 applies the residual error E calculated by the residual error calculation unit 13 to the following Expression 6 obtained from the above Expression 4. As a result, the residual error E is projected in the vertical direction, and as a result, is converted into the displacement amount dz in the vertical direction.

$$dz = \frac{E}{cos θ} \qquad [ Math . 6 ]$$

As described above, since the irradiation direction displacement data is acquired for each reflection point, processing by the displacement amount estimation unit 12, the residual error calculation unit 13, and the residual error conversion unit 14 is performed for each reflection point. Therefore, the displacement amount dz is calculated for each reflection point. Therefore, the filter unit 15 specifies the displacement amount dz that is noise among the plurality of displacement amounts dz calculated for each reflection point, and corrects the specified displacement amount dz.

Specifically, the filter unit 15 spatially arranges each displacement amount dz calculated for each reflection point, and applies a spatial filter to these displacement amounts. Examples of the spatial filter in this case include a Gaussian filter and a moving average filter.

The output unit 16 outputs the displacement amount dx in the bridge axis direction estimated by the displacement amount estimation unit 12 and the displacement amount dz in the vertical direction processed by the filter unit 15 to an external device.

Examples of the external device include a terminal device 40 of the user of the information processing apparatus 10.

### [Device Operation]

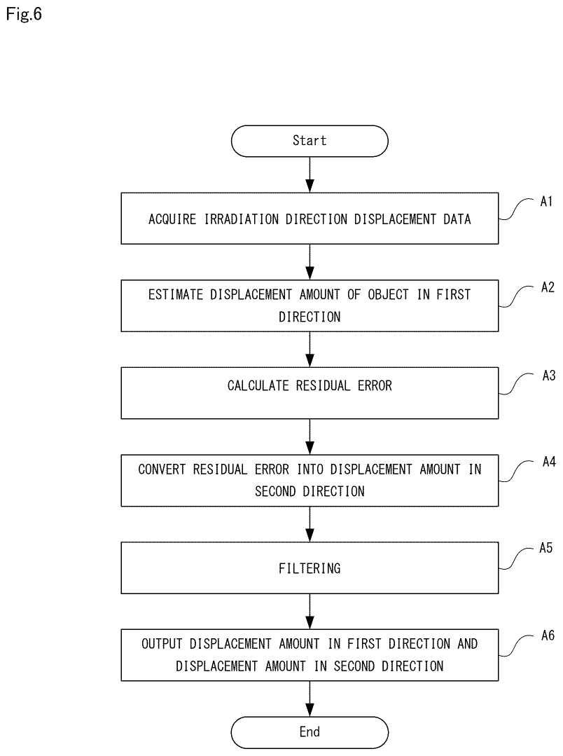

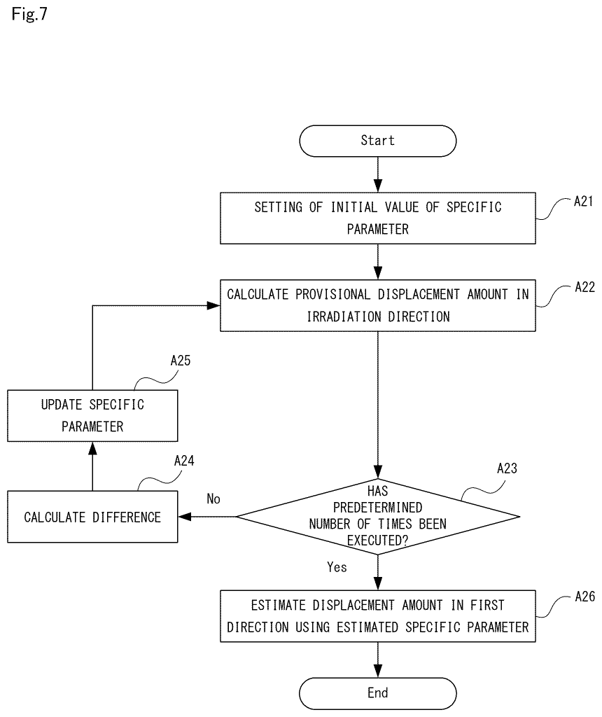

Next, an example of the operation of the information processing apparatus 10 will be described with reference to FIGS. 6 and 7. In the following description, FIGS. 1 to 5 will be appropriately referred to. An information processing method is performed by operating the information processing apparatus 10. Therefore, in the example embodiment, the description of the information processing method is replaced with the following description of the operation of the information processing apparatus 10.

First, the overall operation of the information processing apparatus will be described with reference to FIG. 6. FIG. 6 is a flowchart illustrating an example of the operation of the information processing apparatus.

As illustrated in FIG. 6, first, the data acquisition unit 11 acquires irradiation direction displacement data that indicates a displacement amount generated, in an irradiation direction of an object, by irradiation of a radio wave from the artificial satellite 20 that is a flying object to the bridge 30 that is the object and (step A1).

Specifically, in step A1, the data acquisition unit 11 acquires irradiation direction displacement data at each reflection point of the bridge 30 from the database 21 in which the irradiation direction displacement data is accumulated. The following steps A2 to A4 are performed for each acquired irradiation direction displacement data, that is, for each reflection point.

Next, the displacement amount estimation unit 12 estimates the displacement amount dx in the bridge axial direction (first direction) of the bridge 30 under the physical constraint condition on the bridge 30 (step A2). Step A2 will be described in more detail below with reference to FIG. 7.

Next, the residual error calculation unit 13 calculates the residual error E by subtracting a value obtained by projecting the displacement amount dx in the bridge axis direction estimated in step A2 in the irradiation direction from the displacement amount indicated by the irradiation direction displacement data acquired in step A1 (step A3).

Specifically, in step A3, the residual error calculation unit 13 calculates the residual error E by applying the displacement amount dx in the bridge axis direction estimated in step A2 to the projection equation shown in the above Expression 2.

Next, the residual error conversion unit 14 projects the residual error E calculated in step A3 in the vertical direction (second direction), thereby converting residual error E into displacement amount dz of the bridge 30 in the vertical direction (step A4). Specifically, in step A4, the residual error conversion unit 14 calculates the displacement amount dz by applying the residual error E calculated in step A3 to the following Expression 6.

Next, the filter unit 15 executes filtering on the displacement amount dz calculated in step A4 (step A5). Specifically, in step A5, the filter unit 15 spatially arranges a plurality of displacement amounts dz calculated for each reflection point, and applies a spatial filter to these displacement amounts.

Thereafter, the output unit 16 outputs the displacement amount dx in the bridge axis direction estimated in step A2 and the displacement amount dz in the vertical direction after filtering in step A5 to the external terminal device 40 (step A6).

Next, estimation processing of the displacement amount dz in the bridge axis direction in step A2 will be specifically described with reference to FIG. 7. FIG. 7 is a flowchart specifically illustrating an example of the estimation processing of the displacement amount in the bridge axis direction illustrated in FIG. 6.

As illustrated in FIG. 7, in step A2, first, the displacement amount estimation unit 12 sets the specific parameter Cₓ to an initial value (step A21).

Next, the displacement amount estimation unit 12 calculates a provisional displacement amount dₗₒₛ in the irradiation direction by using the above Expression 3 (step A22).

Next, the displacement amount estimation unit 12 determines whether step A22 and subsequent steps A24 and A25 are executed a predetermined number of times (step A23).

As a result of the determination in step A23, when the provisional displacement has not been executed the predetermined number of times (step A23: No), the displacement amount estimation unit 12 calculates a difference between the provisional displacement amount dₗₒₛ and the displacement amount specified by the irradiation direction displacement data (step A24).

Next, the displacement amount estimation unit 12 updates the specific parameter Cₓ such that the difference calculated in step A24 becomes small (step A25). Thereafter, step A22 is executed again using the updated specific parameter Cₓ.

On the other hand, as a result of the determination in step A23, when the specific parameter Cₓ has been executed the predetermined number of times (step A23: No), the displacement amount estimation unit 12 applies the estimated specific parameter Cₓ to the constraint condition expression of the above Expression 1 to estimate the displacement amount dx in the bridge axis direction (first direction) (step A26). By execution of step A26, step A2 ends.

As described above, the displacement amount estimation unit 12 executes the calculation of the provisional displacement amount dₗₒₛ (step A22), the calculation of the difference (step A24), and the update of parameter Cₓ (step A25) a set number of times. As a result, since the specific parameter Cₓ with high accuracy is obtained, the estimation accuracy of the displacement amount dx is also improved.

### Effects of Example Embodiment

As described above, in the example embodiment, the information processing apparatus 10 can estimate the displacement amounts in the bridge axis direction and the vertical direction on the bridge 30 using only the irradiation direction displacement data obtained from one artificial satellite 20. According to the information processing apparatus 10, it is possible to calculate the displacement amount in a direction according to the object (analysis target) using only one artificial satellite 20.

In the conventional technique disclosed in “2.5-D surface deformation of M6.1 earthquake near Mt Iwate detected by SAR interferometry” (Satoshi Fujiwara et al., Geophysical Research Letters, Vol. 27, No. 14, pp. 2049-2052 Jul. 15, 2000), in order to obtain the displacement amount dz of the bridge in the vertical direction, it is necessary to set a constraint condition expression for the displacement amount dz and model the displacement amount dz. However, since the upper structure of the bridge is different from the floor plate and is different depending on the bridge, it is extremely difficult to model (functionalize) the displacement amount dz. For this reason, in the conventional technique disclosed in “2.5-D surface deformation of M6.1 earthquake near Mt Iwate detected by SAR interferometry” (Satoshi Fujiwara et al., Geophysical Research Letters, Vol. 27, No. 14, pp. 2049-2052 Jul. 15, 2000), there is a problem that the displacement amount dz of the bridge in the vertical direction cannot be accurately obtained.

On the other hand, in the example embodiment, it is not necessary to model displacement amount dz of the bridge 30 in the vertical direction, and displacement amount dz is estimated as residual error E. Therefore, according to the example embodiment, it is possible to accurately obtain the displacement amount dz of the bridge in the vertical direction as compared with the conventional technique.

### [Program]

In the example embodiment, examples of the program include a program for causing a computer to execute steps A1 to A6 illustrated in FIG. 6. When the program is installed and executed in the computer, the information processing apparatus 10 and the information processing method can be achieved. In this case, the processor of the computer functions as a data acquisition unit 11, a displacement amount estimation unit 12, a residual error calculation unit 13, a residual error conversion unit 14, a filter unit 15, and an output unit 16, and performs processing. Examples of the computer include a smartphone and a tablet terminal device in addition to a general-purpose PC and a server computer.

In the example embodiment, the program may be executed by a computer system constructed by a plurality of computers. In this case, for example, each computer may function as any of the data acquisition unit 11, the displacement amount estimation unit 12, the residual error calculation unit 13, the residual error conversion unit 14, the filter unit 15, and the output unit 16.

### [Physical Configuration]

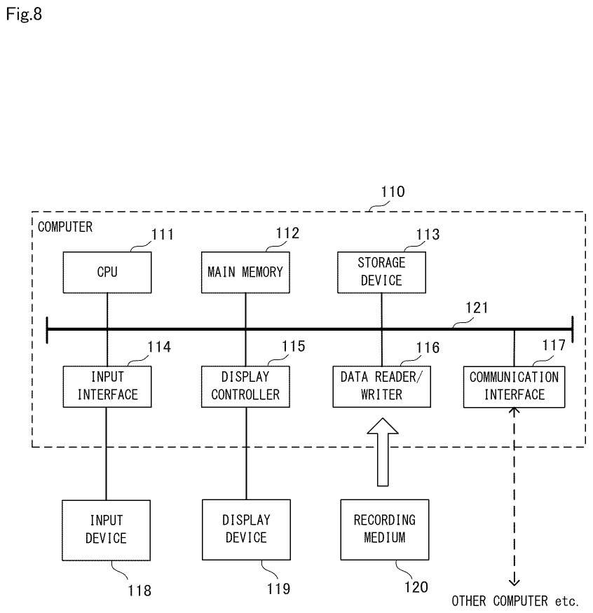

Here, a computer that achieves an information processing apparatus 10 by executing the programs in the example embodiments will be described with reference to FIG. 8. FIG. 8 is a block diagram illustrating an example of the computer that achieves the information processing apparatus.

As illustrated in FIG. 8, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU) or a field-programmable gate array (FPGA) in addition to the CPU 111 or instead of the CPU 111. In this aspect, the GPU or the FPGA can execute the program in the example embodiment.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

The program according to the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as a Compact Flash (CF) (registered trademark) and a Secure Digital (SD), a magnetic recording medium such as a flexible disk, and an optical recording medium such as a compact disk read only memory (CD-ROM).

The information processing apparatus 10 can also be achieved by using hardware related to each unit, for example, an electronic circuit, instead of the computer in which the program is installed. Furthermore, a part of the information processing apparatus 10 may be achieved by a program, and the remaining part may be achieved by hardware. In the example embodiment, the computer is not limited to the computer illustrated in FIG. 8. Some or all of the above-described example embodiments can be expressed by (Supplementary Note 1) to (Supplementary Note 16) described below, but are not limited to the following description.

### (Supplementary Note 1)

An information processing apparatus including:
a data acquisition unit that acquires irradiation direction displacement data that indicates a displacement amount in an irradiation direction of an object, the displacement amount being generated by irradiation of the object with a radio wave from a flying object;
a displacement amount estimation unit that estimates a displacement amount of the object in a first direction under a physical constraint condition on the object;
a residual error calculation unit that calculates a residual error by subtracting a value obtained by projecting the estimated displacement amount in the first direction in the irradiation direction from the displacement amount indicated by the irradiation direction displacement data; and
a residual error conversion unit that projects the calculated residual error in a second direction, thereby converting the residual error into a displacement amount of the object in the second direction.

### (Supplementary Note 2)

The information processing apparatus according to Supplementary Note 1, in which
the physical constraint condition is represented by a constraint condition expression that defines a relationship between a displacement amount in the first direction and a specific parameter, and
the displacement amount estimation unit estimates the specific parameter in the constraint condition expression, and estimates a displacement amount in the first direction by applying the estimated specific parameter to the constraint condition expression.

### (Supplementary Note 3)

The information processing apparatus according to Supplementary Note 1, in which the residual error calculation unit calculates the residual error by applying the estimated displacement amount in the first direction to a projection equation representing the displacement amount in the irradiation direction using the displacement amount in the first direction and the displacement amount in the second direction.

### (Supplementary Note 4)

The information processing apparatus according to Supplementary Note 1, in which
the object is a bridge,
the first direction is a bridge axis direction of the bridge, and
the second direction is a vertical direction.

### (Supplementary Note 5)

An information processing method including:
a data acquisition step of acquiring irradiation direction displacement data that indicates a displacement amount in an irradiation direction of an object, the displacement amount being generated by irradiation of the object with a radio wave from a flying object;
a displacement amount estimation step of estimating a displacement amount of the object in a first direction under a physical constraint condition on the object;
a residual error calculation step of calculating a residual error by subtracting a value obtained by projecting the estimated displacement amount in the first direction in the irradiation direction from the displacement amount indicated by the irradiation direction displacement data; and
a residual error conversion step of projecting the calculated residual error in a second direction, thereby converting the residual error into a displacement amount of the object in the second direction.

### (Supplementary Note 6)

The information processing method according to Supplementary Note 5, further including representing the physical constraint condition by a constraint condition expression that defines a relationship between a displacement amount in the first direction and a specific parameter, in which
in the displacement amount estimation step,
the specific parameter is estimated in the constraint condition expression, and a displacement amount in the first direction is estimated by applying the estimated specific parameter to the constraint condition expression.

### (Supplementary Note 7)

The information processing method according to Supplementary Note 5, in which
in the residual error calculation step,
the residual error is calculated by applying the estimated displacement amount in the first direction to a projection equation representing the displacement amount in the irradiation direction using the displacement amount in the first direction and the displacement amount in the second direction.

### (Supplementary Note 8)

The information processing method according to Supplementary Note 5, in which
the object is a bridge,
the first direction is a bridge axis direction of the bridge, and
the second direction is a vertical direction.

### (Supplementary Note 9)

A computer-readable recording medium having recorded therein a program containing commands to cause a computer to execute:
a data acquisition step of acquiring irradiation direction displacement data that indicates a displacement amount in an irradiation direction of an object, the displacement amount being generated by irradiation of the object with a radio wave from a flying object,
a displacement amount estimation step of estimating a displacement amount of the object in a first direction under a physical constraint condition on the object,
a residual error calculation step of calculating a residual error by subtracting a value obtained by projecting the estimated displacement amount in the first direction in the irradiation direction from the displacement amount indicated by the irradiation direction displacement data, and
a residual error conversion step of projecting the calculated residual error in a second direction, thereby converting the residual error into a displacement amount of the object in the second direction.

### (Supplementary Note 10)

The computer-readable recording medium according to Supplementary note 9, further including representing the physical constraint condition by a constraint condition expression that defines a relationship between a displacement amount in the first direction and a specific parameter, in which
in the displacement amount estimation step,
the specific parameter is estimated in the constraint condition expression, and a displacement amount in the first direction is estimated by applying the estimated specific parameter to the constraint condition expression.

### (Supplementary Note 11)

The computer-readable recording medium according to Supplementary note 9, in which
in the residual error calculation step,
the residual error is calculated by applying the estimated displacement amount in the first direction to a projection equation representing the displacement amount in the irradiation direction using the displacement amount in the first direction and the displacement amount in the second direction.

### (Supplementary Note 12)

The computer-readable recording medium according to Supplementary Note 9, in which
the object is a bridge,
the first direction is a bridge axis direction of the bridge, and
the second direction is a vertical direction.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

As described above, according to the present disclosure, it is possible to calculate a displacement amount in a direction relevant to an analysis target using only one flying object. The present disclosure is useful, for example, in a system that analyzes an infrastructure.

1. An information processing apparatus comprising:
at least one memory storing instructions; and
at least one processor configured to execute the instructions to:
acquire irradiation direction displacement data that indicates a displacement amount in an irradiation direction of an object, the displacement amount being generated by irradiation of the object with a radio wave from a flying object;
estimate a displacement amount of the object in a first direction under a physical constraint condition on the object;
calculate a residual error by subtracting a value obtained by projecting the estimated displacement amount in the first direction in the irradiation direction from the displacement amount indicated by the irradiation direction displacement data; and
project the calculated residual error in a second direction, thereby converting the residual error into a displacement amount of the object in the second direction.

2. The information processing apparatus according to claim 1, wherein
the physical constraint condition is represented by a constraint condition expression that defines a relationship between a displacement amount in the first direction and a specific parameter, and
at least one processor estimates the specific parameter in the constraint condition expression, and estimates a displacement amount in the first direction by applying the estimated specific parameter to the constraint condition expression.

3. The information processing apparatus according to claim 1, wherein
at least one processor calculates the residual error by applying the estimated displacement amount in the first direction to a projection equation representing the displacement amount in the irradiation direction using the displacement amount in the first direction and the displacement amount in the second direction.

4. The information processing apparatus according to claim 1, wherein
the object is a bridge,
the first direction is a bridge axis direction of the bridge, and
the second direction is a vertical direction.

5. An information processing method for causing a computer to execute:
acquiring irradiation direction displacement data that indicates a displacement amount in an irradiation direction of an object, the displacement amount being generated by irradiation of the object with a radio wave from a flying object;
estimating a displacement amount of the object in a first direction under a physical constraint condition on the object;
calculating a residual error by subtracting a value obtained by projecting the estimated displacement amount in the first direction in the irradiation direction from the displacement amount indicated by the irradiation direction displacement data; and
projecting the calculated residual error in a second direction, thereby converting the residual error into a displacement amount of the object in the second direction.

6. The information processing method according to claim 5, further comprising representing the physical constraint condition by a constraint condition expression that defines a relationship between a displacement amount in the first direction and a specific parameter, wherein
in the estimating of the displacement amount,
the specific parameter is estimated in the constraint condition expression, and a displacement amount in the first direction is estimated by applying the estimated specific parameter to the constraint condition expression.

7. The information processing method according to claim 5, wherein
in the calculating of the residual error,
the residual error is calculated by applying the estimated displacement amount in the first direction to a projection equation representing the displacement amount in the irradiation direction using the displacement amount in the first direction and the displacement amount in the second direction.

8. The information processing method according to claim 5, wherein
the object is a bridge,
the first direction is a bridge axis direction of the bridge, and
the second direction is a vertical direction.

9. A non-transitory computer-readable recording medium having recorded therein a program for causing a computer to execute:
acquiring irradiation direction displacement data that indicates a displacement amount in an irradiation direction of an object, the displacement amount being generated by irradiation of the object with a radio wave from a flying object;
estimating a displacement amount of the object in a first direction under a physical constraint condition on the object;
calculating a residual error by subtracting a value obtained by projecting the estimated displacement amount in the first direction in the irradiation direction from the displacement amount indicated by the irradiation direction displacement data; and
projecting the calculated residual error in a second direction, thereby converting the residual error into a displacement amount of the object in the second direction.

10. The non-transitory computer-readable recording medium according to claim 9, wherein
the physical constraint condition is represented by a constraint condition expression that defines a relationship between a displacement amount in the first direction and a specific parameter, and
in the estimating of the displacement amount,
the computer executes estimating the specific parameter in the constraint condition expression, and estimating a displacement amount in the first direction by applying the estimated specific parameter to the constraint condition expression.

11. The non-transitory computer-readable recording medium according to claim 9, wherein
in the calculating of the residual error,
the computer executes calculating the residual error by applying the estimated displacement amount in the first direction to a projection equation representing the displacement amount in the irradiation direction using the displacement amount in the first direction and the displacement amount in the second direction.

12. The non-transitory computer-readable recording medium according to claim 9, wherein
the object is a bridge,
the first direction is a bridge axis direction of the bridge, and
the second direction is a vertical direction.
